(19) United States
(12) Patent Application Publication
(10) Pub. No.: US 2020/0340514 A1
(43) Pub. Date: Oct. 29, 2020

(54) FASTENER STRUCTURE

(71) Applicant: FIVETECH TECHNOLOGY INC., New Taipei City (TW)

(72) Inventor: TING-JUI WANG, New Taipei City (TW)

(21) Appl. No.: 16/846,426

(22) Filed: Apr. 13, 2020

(30) Foreign Application Priority Data
Apr. 24, 2019 (TW) 108205086

(51) Int. Cl. F16B 19/10

(52) U.S. Cl. CPC F16B 19/1027

(57) ABSTRACT

A fastener structure includes a body portion, a control portion and a fastening portion. The control portion is movably fitted to the body portion. The control portion has a head portion and a limiting portion. The fastening portion is movably disposed at the body portion. The limiting portion is adapted to limit the fastening portion. Therefore, the body portion is disposed at the second object, and the control portion causes the fastening portion to be coupled to or separated from the first object, so as to couple together and separate at least two objects repeatedly and rapidly.

### CROSS-REFERENCE TO RELATED APPLICATION

This non-provisional application claims priority under 35 U.S.C. § 119(a) on Patent Application No(s). 108205086 filed in Taiwan, R.O.C. on Apr. 24, 2019, the entire contents of which are hereby incorporated by reference.

### BACKGROUND OF THE INVENTION

### 1. Field of the Invention

The present disclosure relates to fastener structures, and in particular to a fastener structure for coupling together and separating at least two objects repeatedly and rapidly.

### 2. Description of the Related Art

Conventionally, coupling together at least two objects requires fastening them together with screws.

Although the aforesaid prior art is effective in coupling together at least two objects to render them inseparable, the aforesaid prior art not only fails to render the coupling process easy but its use of screws also renders at least one object difficult to demount.

Therefore, it is an objective of the present disclosure to provide a fastener structure for coupling together and separating at least two objects repeatedly and rapidly.

### BRIEF SUMMARY OF THE INVENTION

An objective of the present disclosure is to provide a fastener structure for coupling together and separating at least two objects repeatedly and rapidly.

To achieve at least the above objective, the present disclosure provides a fastener structure, comprising a body portion, a control portion and a fastening portion. The control portion is movably fitted to the body portion and has a head portion and a limiting portion. The fastening portion is movably disposed at the body portion. The limiting portion is adapted to limit or control the fastening portion.

Regarding the fastener structure, the body portion has a fitting portion for fitting to a second object, or the body portion and the second object are integrally formed.

Regarding the fastener structure, the fitting portion fits to the second object by riveting, fastening, expanding, welding or locking.

Regarding the fastener structure, the control portion or the body portion has a receiving portion which the fastening portion enters when the limiting portion exits a limiting position.

Regarding the fastener structure, the fastening portion is aligned with the body portion laterally or vertically.

Regarding the fastener structure, the control portion has another fastening portion for limiting a third object, a first object or an object.

Regarding the fastener structure, the control portion has a blocking portion, and the body portion has a corresponding blocking portion for blocking the blocking portion.

Regarding the fastener structure, the head portion is a movable element to be pressed in order to cause the limiting portion to move.

Regarding the fastener structure, the head portion is a lateral push element to be moved laterally or rotated laterally in order to cause the limiting portion to block movably.

Regarding the fastener structure, the fastening portion and the body portion are integrally formed.

The fastener structure further comprises a resilient component with two ends abutting against the body portion and the control portion, respectively, to keep the limiting portion at a limiting position normally.

Regarding the fastener structure, the movable element is moved upward to allow the limiting portion to exit the limiting position and moved downward to allow the limiting portion to enter the limiting position.

Regarding the fastener structure, the head portion and the limiting portion are coupled together by a coupling portion.

Regarding the fastener structure, the coupling portion is a bolt, fastener, post, or the coupling portion and the head portion are integrally formed, or the coupling portion and the limiting portion are integrally formed.

Regarding the fastener structure, the lateral push element has an entering portion and a lifting portion, wherein the head portion causes the limiting portion to exit the limiting position while descending at the entering portion, or the head portion causes the limiting portion to stay at the limiting position while staying at the lifting portion.

Regarding the fastener structure, the fastening portion and the another fastening portion laterally limit a first object and vertically limit the third object simultaneously.

Regarding the fastener structure, the fastening portion and the another fastening portion simultaneously limit two different objects or the same object laterally and vertically.

Regarding the fastener structure, the fastening portion is adapted to limit two objects laterally or vertically.

Regarding the fastener structure, the fastening portion or the another fastening portion is a sphere, roller, pyramid, post, block, thread, inward fastener or outward fastener.

Regarding the fastener structure, the fitting portion is aligned with the body portion laterally or vertically.

Regarding the fastener structure, the fastening portion or the another fastening portion is aligned with the body portion laterally or vertically.

Regarding the fastener structure, the fitting portion and the fastening portion are aligned with the body portion laterally or vertically, or the fitting portion and the fastening portion are aligned with the body portion laterally, or the fitting portion and the fastening portion are aligned with the body portion vertically.

Regarding the fastener structure, the fastening portion or the another fastening portion is aligned with the body portion laterally or vertically, or the fastening portion or the another fastening portion is aligned with the body portion laterally, or the fastening portion or the another fastening portion is aligned with the body portion vertically.

Regarding the fastener structure, a displacement of the fastening portion into the receiving portion is equal to or approximates to a limitation range or interference range by which the fastening portion limits an object.

Regarding the fastener structure, a displacement of the another fastening portion toward the body portion is equal to or approximates to a limitation range or interference range by which the another fastening portion limits an object.

Regarding the fastener structure, the body portion has a stopping portion for stopping and limiting the fastening portion so as to prevent separation of the fastening portion from the body portion.

Regarding the fastener structure, the movable element is moved downward to cause the limiting portion to exit the limiting position and upward to cause the limiting portion to enter the limiting position.

Regarding the fastener structure, the lateral push element has an entering portion and a lifting portion, wherein the head portion causes the limiting portion to exit or stay at the limiting position while descending at the entering portion, or the head portion causes the limiting portion to stay at or exit the limiting position while staying at the lifting portion.

Regarding the fastener structure, the body portion is deformed under an applied force to form the stopping portion for stopping and limiting the fastening portion, such that the stopping portion prevents separation of the fastening portion from the body portion.

Regarding the fastener structure, a width of the stopping portion is less than a stopping width of the fastening portion, such that the stopping portion stops and limits the fastening portion to prevent separation of the fastening portion from the body portion.

Regarding the fastener structure, the fastening portion and the another fastening portion laterally limit the first object and vertically limit the third object.

Regarding the fastener structure, the fastening portion or the another fastening portion is aligned with the body portion laterally or vertically, or the fastening portion is aligned with the body portion laterally, the another fastening portion is aligned with the body portion vertically, or fastening portion is aligned with the body portion vertically, the another fastening portion is aligned with the body portion laterally.

Regarding the fastener structure, the fitting portion and the fastening portion are aligned with the body portion laterally or vertically, or the fitting portion is aligned with the body portion laterally, and the fastening portion is aligned with the body portion vertically, or the fitting portion is aligned with the body portion vertically, and the fastening portion is aligned with the body portion laterally.

Regarding the fastener structure, the limiting portion is a raised portion, dented portion, plane portion, step portion, oblique surface portion, arcuate surface portion, curved surface portion, hole portion or groove portion.

Regarding the fastener structure, the receiving portion is a raised portion, dented portion, plane portion, step portion, oblique surface portion, arcuate surface portion, curved surface portion, hole portion or groove portion.

Regarding the fastener structure, the body portion is deformed under an applied force to form the stopping portion for stopping and limiting the fastening portion, such that the stopping portion prevents separation of the fastening portion from the body portion.

Regarding the fastener structure, the fastening portion and another fastening portion are controlled by the head portion and adapted to effect fastening simultaneously or sequentially.

Regarding the fastener structure, the head portion of the control portion is a handle.

Regarding the fastener structure, the head portion of the control portion is a handle, and the head portion is connected to one or two body portions.

Therefore, the fastener structure of the present disclosure, the body portion is disposed at the second object, and the control portion causes the fastening portion to be coupled to or removed from the first object, to couple together and separate at least two objects repeatedly and rapidly.

### BRIEF DESCRIPTION OF THE DRAWINGS

FIG. 1 is a schematic view of a fastener structure according to the first embodiment of the present disclosure.

FIG. 2 is a schematic view of the fastener structure according to the first embodiment of the present disclosure.

FIG. 3 is a schematic view of a fastening portion and another fastening portion in different forms according to the present disclosure.

FIG. 4 is a schematic view of the fastener structure according to the second embodiment of the present disclosure.

FIG. 5 is a schematic view of the fastener structure according to the third embodiment of the present disclosure.

FIG. 6 is a schematic view of a head portion in another form according to the present disclosure.

FIG. 7 is a schematic view of the fastener structure according to the fourth embodiment of the present disclosure.

FIG. 8 is a schematic view of the fastener structure according to the fifth embodiment of the present disclosure.

FIG. 9 is a schematic view of the fastener structure according to the sixth embodiment of the present disclosure.

FIG. 10 is a schematic view of the fastener structure according to the seventh embodiment of the present disclosure.

FIG. 11 is a schematic view of the fastener structure according to the eighth embodiment of the present disclosure.

FIG. 12 is a schematic view of the fastener structure according to the ninth embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

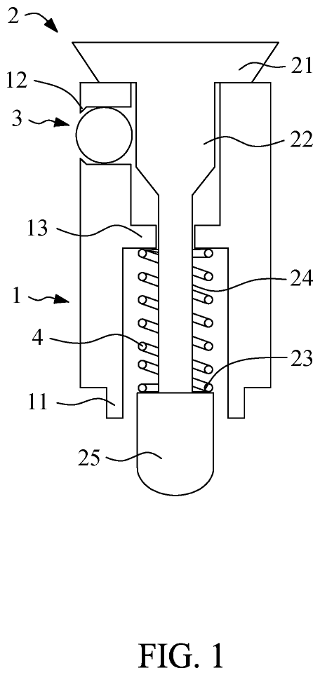

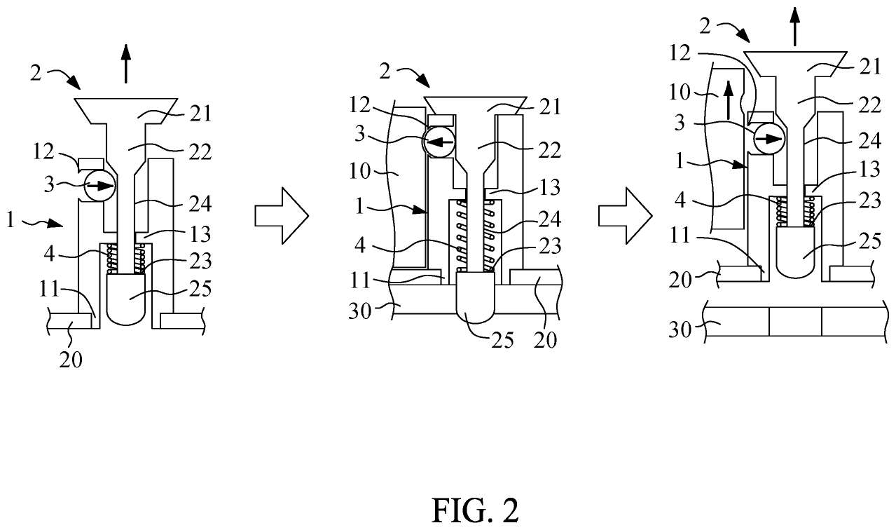

Referring to FIG. 1 and FIG. 2, the present disclosure provides a fastener structure 1, comprising a body portion 1, a control portion 2 and a fastening portion 3.

The control portion 2 is movably fitted to the body portion 1. The control portion 2 has a head portion 21, a limiting portion 22 and a blocking portion 23.

The fastening portion 3 is movably disposed at the body portion 1. The limiting portion 22 is adapted to limit or control the fastening portion 3 by blocking the fastening portion 3, thereby allowing the fastening portion 3 to limit a first object 10.

To start using the fastener structure, the body portion 1 is fixedly disposed at a second object 20, and then the head portion 21 is pulled, such that the control portion 2 moves upward, and the limiting portion 22 exits the position conducive to its limiting the fastening portion 3. Then, the fastening portion 3 moves into the body portion 1. After that, the first object 10 is disposed on one side of the body portion 1 and corresponds in position to the fastening portion 3. Next, the control portion 2 is moved downward to cause the limiting portion 22 to stop the fastening portion 3 from laterally engaging with the first object 10. To separate the first object 10 from the fastener 3, the user pulls the head portion 21, such that the control portion 2 moves upward, and thus the fastening portion 3 moves into the body portion 1. Therefore, the fastener structure of the present disclosure is effective in coupling together and separating two objects (the first object 10 and the second object 20) repeatedly and rapidly.

In a preferred embodiment of the present disclosure, the body portion 1 has a fitting portion 11 adapted to fit to the second object 20. Therefore, the body portion 1 is firmly disposed at the second object 20, such that the control portion 2 and the fastening portion 3 move steadily on the body portion 1. Alternatively, the body portion 1 and the second object 20 are integrally formed (not shown), such that the present disclosure meets practical needs.

In a preferred embodiment of the present disclosure, the fitting portion 11 fits to the second object 20 by riveting, fastening, expanding, welding, or locking. Therefore, the body portion 1 is firmly disposed at the second object 20, such that the control portion 2 moves steadily on the holder 1, such that the present disclosure meets practical needs.

In a preferred embodiment of the present disclosure, the fitting portion 11 is aligned with the body portion 1 vertically. Therefore, the body portion 1 is coupled to the second object 20 vertically through the fitting portion 11, such that the present disclosure meets practical needs.

In a preferred embodiment of the present disclosure, the fitting portion 11 and the fastening portion 3 are aligned with the body portion laterally or vertically, or the fitting portion 11 and the fastening portion 3 are aligned with the body portion 1 laterally and located at different positions, or the fitting portion 11 and the fastening portion 3 are aligned with the body portion 1 vertically and located at different positions (not shown), such that the present disclosure meets practical needs.

In a preferred embodiment of the present disclosure, the body portion 1 has a stopping portion 12 adapted to stop and limit the fastening portion 3 and adapted to prevent separation of the fastening portion 3 from the body portion 1.

In a preferred embodiment of the present disclosure, the control portion 2 has a receiving portion 24. The user pulls the head portion 21, such that the control portion 2 moves upward, and the limiting portion 22 exits the position conducive to limiting the fastening portion 3. Then, the fastening portion 3 moves into the body portion 1 and enters the receiving portion 24 to trigger separation of the fastener 3 and the first object 10. The receiving portion 24 is a raised portion, dented portion, plane portion, step portion, oblique surface portion, arcuate surface portion, curved surface portion, hole portion or groove portion, such that the present disclosure meets practical needs.

In a preferred embodiment of the present disclosure, a displacement of the fastening portion 3 into the receiving portion 24 is equal to or approximates to a limitation range or interference range by which the fastening portion 3 limits the first object 10.

In a preferred embodiment of the present disclosure, the fastening portion 3 is aligned with the body portion 1 laterally or vertically. In this embodiment, the fastening portion 3 is aligned with the body portion 1 laterally and thus coupled to the second object 20 from one side of the body portion 1. Therefore, the present disclosure meets practical needs.

In a preferred embodiment of the present disclosure, the control portion 2 has another fastening portion 25 for limiting a third object 30 (or the first object or an object). The fastening portion 3 and the another fastening portion 25 laterally limit the first object 10 and vertically limit the third object 30 simultaneously. Therefore, the body portion 1 is disposed at the second object 20, whereas the fastening portion 3 and the another fastening portion 25 limit the first object 10 and the third object 30 simultaneously, such that the present disclosure meets practical needs.

The fastening portion 3 and the another fastening portion 25 limit an object (not shown) both laterally and vertically, such that the present disclosure meets practical needs.

In a preferred embodiment of the present disclosure, the fastening portion 3 and the another fastening portion 25 are aligned with the body portion 1 laterally and vertically, such that the fastening portion 3 and the another fastening portion 25 limit the first object 10 and the third object 30 in different directions (laterally and vertically), such that the present disclosure meets practical needs.

In a preferred embodiment of the present disclosure, the fastening portion 3 and the another fastening portion 25 are aligned with the body portion 1 laterally or vertically, or the fastening portion 3 and the another fastening portion 25 are aligned with the body portion 1 laterally and located at different positions, or the fastening portion 3 and the another fastening portion 25 are aligned with the body portion 1 vertically and located at different positions (not shown), such that the present disclosure meets practical needs.

In a preferred embodiment of the present disclosure, a displacement of the another fastening portion 25 toward the body portion 1 is equal to or approximates to a limitation range or interference range by which the another fastening portion 25 limits the third object 30.

In a preferred embodiment of the present disclosure, the body portion 1 has a corresponding blocking portion 13 for blocking the blocking portion 23. In an embodiment of the present disclosure, the fastener structure further comprises a resilient component 4. Two ends of the resilient component 4 abut against the corresponding blocking portion 13 of the body portion 1 and the blocking portion 23 of the control portion 2, respectively, so as to cause the limiting portion 22 to abut against the limiting portion 3, thereby allowing the limiting portion 3 to stay at a limiting position normally.

In a preferred embodiment of the present disclosure, the fastening portion 3 or the another fastening portion 25 is aligned with the body portion 1 laterally or vertically. In this embodiment, the fastening portion 3 is aligned with the body portion 1 laterally, and the another fastening portion 25 is aligned with the body portion 1 vertically, such that the present disclosure meets practical needs.

In a preferred embodiment of the present disclosure, the fitting portion 11 and the fastening portion 3 are aligned with the body portion 1 laterally or vertically. In this embodiment, the fitting portion 11 is aligned with the body portion 1 vertically, and the fastening portion 3 is aligned with the body portion 1 laterally, such that the present disclosure meets practical needs.

In a preferred embodiment of the present disclosure, the limiting portion 22 is a raised portion, dented portion, plane portion, step portion, oblique surface portion, arcuate surface portion, curved surface portion, hole portion or groove portion, such that the present disclosure meets practical needs.

In a preferred embodiment of the present disclosure, the fastening portion 3 and the another fastening portion 25 are controlled by the head portion 21 and adapted to effect fastening simultaneously or sequentially, such that the present disclosure meets practical needs.

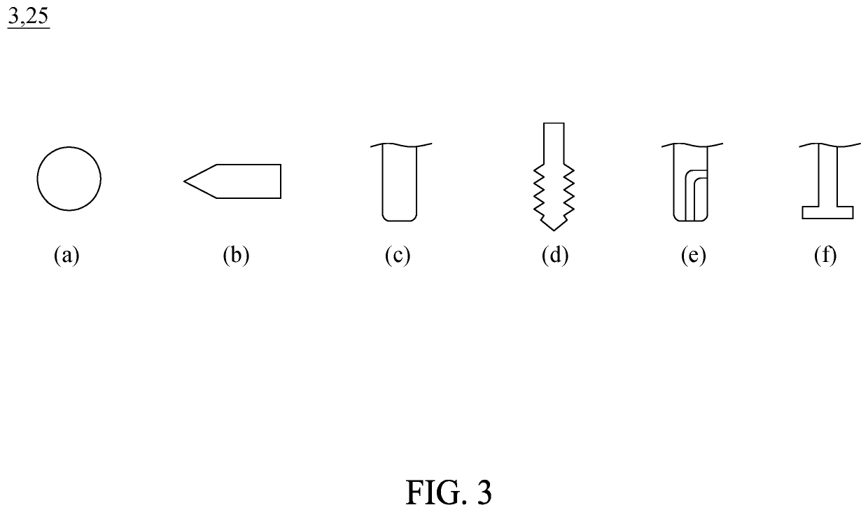

Referring to FIG. 3, in a preferred embodiment of the present disclosure, the fastening portion 3 or the another fastening portion 25 is a sphere (part a of FIG. 3), roller, pyramid (part b of FIG. 3), post (part c of FIG. 3), block, thread (part d of FIG. 3), inward fastener (part e of FIG. 3) or outward fastener (part f of FIG. 3), such that the present disclosure meets practical needs.

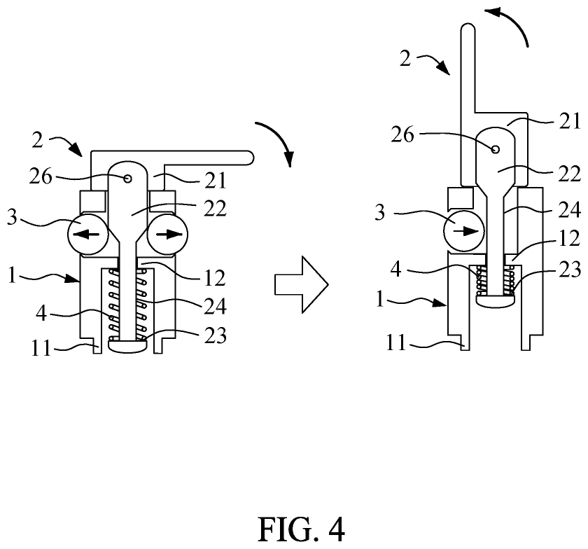

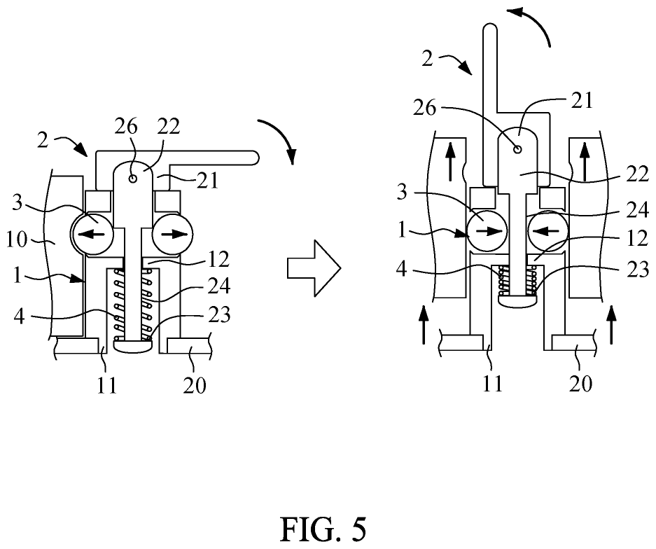

Referring to FIG. 4 and FIG. 5, in a preferred embodiment of the present disclosure, the head portion 21 is a movable element adapted to be moved so as to cause the limiting portion 22 to move. The head portion 21 and the limiting portion 22 are coupled together by a coupling portion 26.

To start using the fastener structure, the movable element (the head portion 21) is moved upward to cause the limiting portion 22 to exit (or enter) the limiting position, such that the limiting portion 22 exits the position conducive to limiting the fastening portion 3. Then, the fastening portion 3 moves into the body portion 1 and enters the receiving portion 24 to trigger separation of the fastener 3 and the first object 10. When the movable element (the head portion 21) is moved downward to cause the limiting portion 22 to enter (or exit) the limiting position and thus allow the fastening portion 3 to be engaged with the first object 10, thereby coupling together and separating two objects (the first object 10 and the second object 20) repeatedly and rapidly.

In a preferred embodiment of the present disclosure, the coupling portion 26 is a bolt, fastener, or post, or the coupling portion 26 and the head portion 21 are integrally formed, or the coupling portion 26 and the limiting portion 22 are integrally formed, such that the present disclosure meets practical needs.

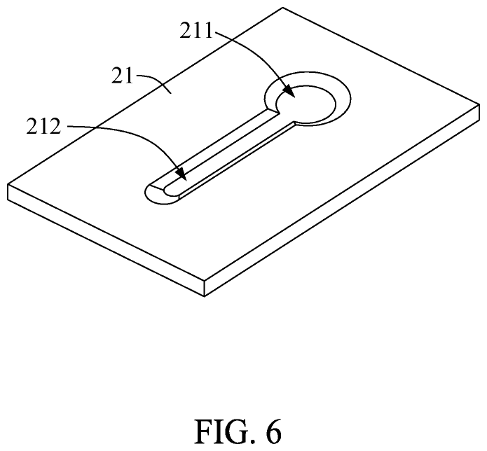

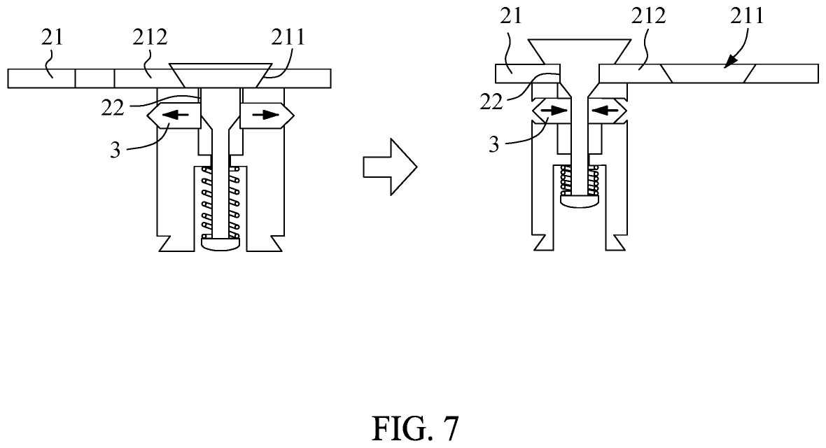

Referring to FIG. 6 and FIG. 7, in a preferred embodiment of the present disclosure, the head portion 21 is a lateral push element adapted to laterally move or laterally rotate, such that the limiting portion 22 moves and blocks. Consequently, the limiting portion 22 exits or enters the limiting position, thereby separating or coupling together the fastening portion 3 and an object. Therefore, the fastener structure of the present disclosure is effective in coupling together and separating two objects repeatedly and rapidly.

In a preferred embodiment of the present disclosure, the lateral push element (the head portion 21) has an entering portion 211 and a lifting portion 212. The head portion 21 causes the limiting portion 22 to exit (or stay at) the limiting position while descending at the entering portion 211. The head portion 21 causes the limiting portion 22 to stay at (or exit) the limiting position while staying at the lifting portion 212. Therefore, the present disclosure meets practical needs.

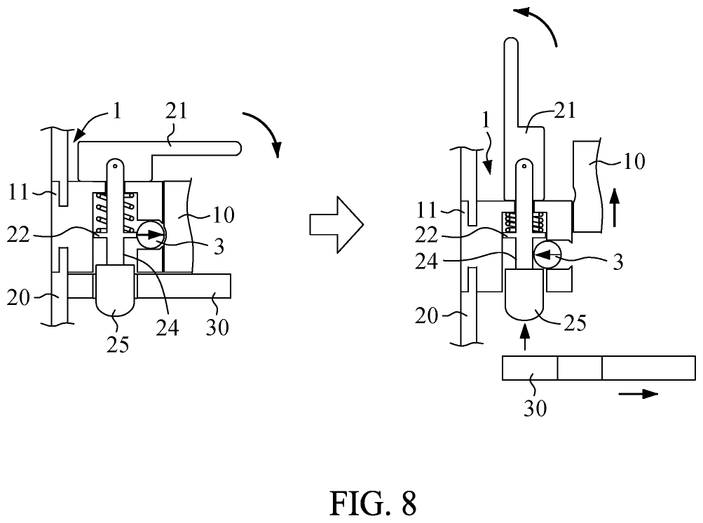

Referring to FIG. 8, in a preferred embodiment of the present disclosure, the fitting portion 11 is aligned with the body portion 1 laterally. The fastening portion 3 is aligned with the body portion 1 vertically. The another fastening portion 25 is aligned with the body portion 1 laterally. Thus, the body portion 1 is laterally coupled to the second object 20. To start using the fastener structure, the movable element (the head portion 21) is moved upward to cause the limiting portion 22 to exit the limiting position. Hence, the limiting portion 22 not only exits the position conducive to limiting the fastening portion 3 but also drives the another fastening portion 25 upward, such that the fastening portion 3 moves into the body portion 1 and enters the receiving portion 24 to trigger separation of the fastener 3 and the first object 10. Furthermore, the movable element (the head portion 21) is moved downward to cause the limiting portion 22 to enter the limiting position, so as to not only allow the fastening portion 3 to be engaged with the first object 10 laterally but also allow the another fastening portion 25 to be engaged with the third object 30 vertically. Therefore, the fastener structure of the present disclosure is effective in coupling together and separating three objects (the first object 10, the second object 20, and the third object 30) repeatedly and rapidly.

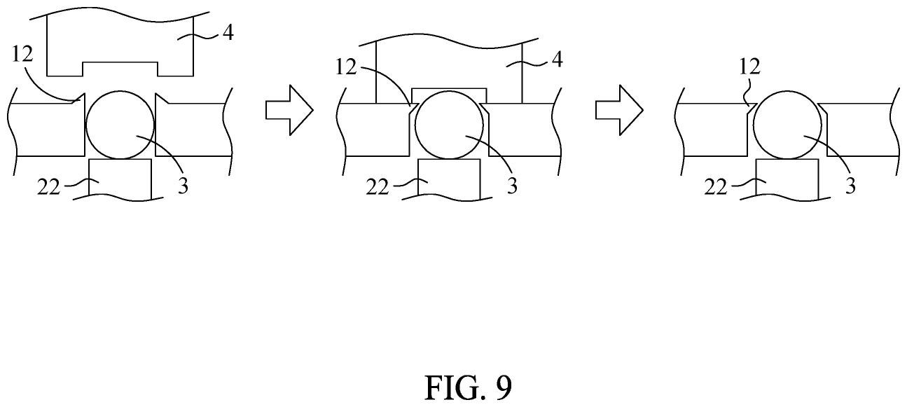

Referring to FIG. 9, in a preferred embodiment of the present disclosure, the stopping portion 12 is deformed under a force exerted thereon with a tool 40 so as to stop and limit the fastening portion 3. The width of the stopping portion 12 is less than the stopping width of the fastening portion 3, so as for the stopping portion 12 to stop and limit the fastening portion 3. Thus, the fastening portion 3 is prevented from separating from the body portion 1, such that the present disclosure meets practical needs.

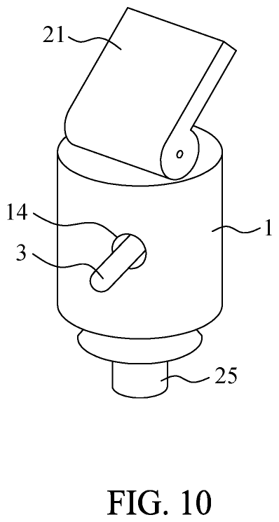

Referring to FIG. 10, in a preferred embodiment of the present disclosure, one side of the body portion 1 has a receiving portion 14 for moving the head portion 21. When the limiting portion (not shown) exits or enters the limiting position, the fastening portion 3 laterally enters or exits the receiving portion 14 to remove or limit the required object, and the another fastening portion 25 vertically removes or limits the required another object (or the same object as limited by the fastening portion 3), Therefore, the fastening portion 3 and the another fastening portion 25 simultaneously limit two different objects or the same object, such that the present disclosure meets practical needs.

In a preferred embodiment of the present disclosure, the receiving portion 14 is a raised portion, dented portion, plane portion, step portion, oblique surface portion, arcuate surface portion, curved surface portion, hole portion or groove portion, such that the present disclosure meets practical needs.

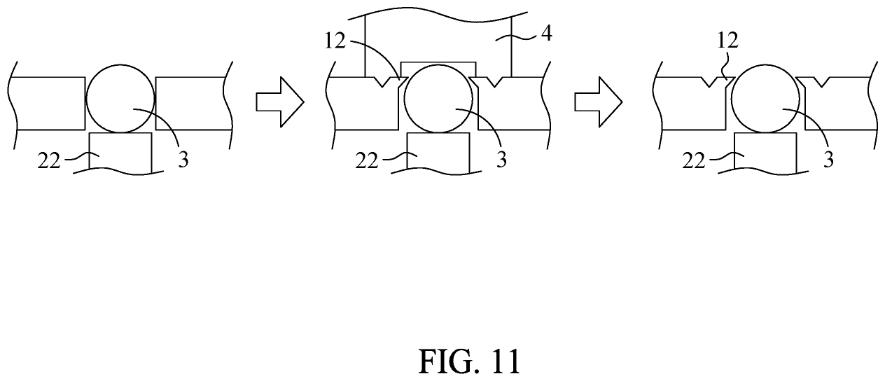

Referring to FIG. 11, in a preferred embodiment of the present disclosure, the body portion 1 is deformed under an applied force exerted with the tool 40 to form on the body portion 1 the stopping portion 12 for stopping and limiting the fastening portion 3, such that the stopping portion 12 prevents separation of the fastening portion 3 from the body portion 1. Therefore, the present disclosure meets practical needs.

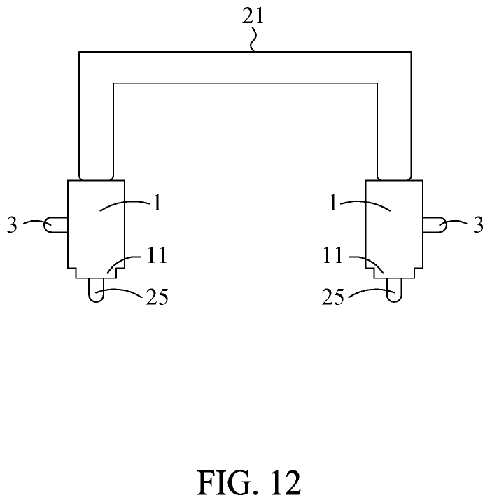

Referring to FIG. 12, in a preferred embodiment of the present disclosure, the head portion 21 of the control portion 2 is a U-shaped handle, and the head portion 21 is connected to one or two body portions 1. In this embodiment, two ends of the head portion 21 are connected to one body portion 1.

Therefore, the body portion 1 is vertically coupled to the second object through the fitting portion 11, and then the first object is disposed on one side of the body portion 1 and corresponds in position to the fastening portion 3. Next, the control portion 2 is moved downward. Hence, the limiting portion 22 abuts against the fastening portion 3 laterally so as to be engaged with the first object; consequently, the fastening portion 3 and the another fastening portion 25 limit the first object and the third object in different directions (laterally and vertically). The user manipulates the fastener structure by gripping the head portion 21, which is a U-shaped handle. Therefore, the present disclosure meets practical needs.

While the present disclosure has been described by means of specific embodiments, numerous modifications and variations could be made thereto by those skilled in the art without departing from the scope and spirit of the present disclosure set forth in the claims.

What is claimed is:

1. A fastener structure, comprising:
a body portion;
a control portion movably fitted to the body portion and having a head portion and a limiting portion; and
a fastening portion movably disposed at the body portion and limited or controlled by the limiting portion.

2. The fastener structure of claim 1, wherein the body portion has a fitting portion adapted to fit to a second object, or the body portion and the second object are integrally formed, wherein the fitting portion fits to the second object by riveting, fastening, expanding, welding, or locking.

3. The fastener structure of claim 1, wherein the control portion or the body portion has a receiving portion which the fastening portion enters when the limiting portion exits the limiting position.

4. The fastener structure of claim 1, wherein the fastening portion is aligned with the body portion laterally or vertically, and a displacement of the fastening portion into the receiving portion is equal to or approximates to a limitation range or interference range by which the fastening portion limits an object.

5. The fastener structure of claim 1, wherein the control portion has another fastening portion for limiting a third object, a first object or an object, wherein the fastening portion and the another fastening portion laterally limit the first object and vertically limit the third object, or the fastening portion and the another fastening portion laterally and vertically limit two different objects or the same object.

6. The fastener structure of claim 1, wherein the control portion has a blocking portion, and the body portion has a corresponding blocking portion for blocking the blocking portion.

7. The fastener structure of claim 1, wherein the head portion is a movable element adapted to be moved so as to cause the limiting portion to move, wherein the movable element is moved upward to cause the limiting portion to exit the limiting position and downward to cause the limiting portion to enter the limiting position, or the movable element is moved downward to cause the limiting portion to exit the limiting position and upward to cause the limiting portion to enter the limiting position.

8. The fastener structure of claim 1, wherein the head portion is a lateral push element adapted to laterally move or laterally rotate, such that the limiting portion moves and blocks, wherein the lateral push element has an entering portion and a lifting portion, wherein the head portion causes the limiting portion to exit or stay at the limiting position while descending at the entering portion, or the head portion causes the limiting portion to stay at or exit the limiting position while staying at the lifting portion.

9. The fastener structure of claim 1, further comprising a resilient component with two ends abutting against the body portion and the control portion, respectively, thereby causing the limiting portion to stay at the limiting position normally.

10. The fastener structure of claim 1, wherein the head portion and the limiting portion are coupled together by a coupling portion, and the coupling portion is a bolt, fastener, or post, or the coupling portion and the head portion are integrally formed, or the coupling portion and the limiting portion are integrally formed.

11. The fastener structure of claim 5, wherein the fastening portion or the another fastening portion is aligned with the body portion laterally or vertically, or the fastening portion is aligned with the body portion laterally, the another fastening portion is aligned with the body portion vertically, or fastening portion is aligned with the body portion vertically, the another fastening portion is aligned with the body portion laterally, or the fitting portion and the fastening portion is aligned with the body portion laterally or vertically, or the fitting portion is aligned with the body portion laterally, the fastening portion is aligned with the body portion vertically, or the fitting portion is aligned with the body portion vertically, the fastening portion is aligned with the body portion laterally.

12. The fastener structure of claim 2, wherein the fitting portion and the fastening portion are aligned with the body portion laterally or vertically, or the fitting portion and the fastening portion are aligned with the body portion laterally, or the fitting portion and the fastening portion are aligned with the body portion vertically.

13. The fastener structure of claim 5, wherein a displacement of the another fastening portion toward the body portion is equal to or approximates to a limitation range or interference range by which the another fastening portion limits an object.

14. The fastener structure of claim 1, wherein the body portion has a stopping portion for stopping and limiting the fastening portion to prevent separation of the fastening portion from the body portion.

15. The fastener structure of claim 14, wherein a width of the stopping portion is less than a stopping width of the fastening portion, such that the stopping portion stops and limits the fastening portion to prevent separation of the fastening portion from the body portion.

16. The fastener structure of claim 14, wherein the body portion is deformed under an applied force to form the stopping portion for stopping and limiting the fastening portion, such that the stopping portion prevents separation of the fastening portion from the body portion.

17. The fastener structure of claim 1, wherein the fastening portion and another fastening portion are controlled by the head portion to effect fastening simultaneously or sequentially.

18. The fastener structure of claim 1, wherein the head portion of the control portion is a handle.

19. The fastener structure of claim 1, wherein the head portion of the control portion is a handle, and the head portion is connected to one or two body portions.
